(19) United States
(12) Patent Application Publication
(10) Pub. No.: US 2023/0192973 A1
(43) Pub. Date: Jun. 22, 2023

(54) COLLATION SHRINK FILM

(71) Applicant: Dow Global Technologies LLC, Midland, MI (US)

(72) Inventors: Weiming Ma, Shanghai (CN); Shenglong Chen, Shanghai (CN); Jichang Feng, Shanghai (CN); Danielle Sook Leng Lee, Selangor (CN); Suny Markose, Singapore (SG); Nimisha Pathare, Mumbai (IN)

(73) Assignee: Dow Global Technologies LLC, Midland, MI (US)

(21) Appl. No.: 17/924,978

(22) PCT Filed: May 10, 2021
(86) PCT No.: PCT/US2021/031480

§ 371 Date: Nov. 11, 2022

(30) Foreign Application Priority Data
May 11, 2020 (IN) 202041019778

(51) Int. Cl. C08J 5/18

(52) U.S. Cl. CPC C08J 5/18; C08J 2323/06

(57) ABSTRACT

A shrink film comprising a monolayer or multi-layer film having at least one layer comprising a formulated resin; wherein the formulated resin comprises: a post-consumer recycled resin sourced from recycled high density polyethylene (HDPE) resin; wherein the post-consumer recycled resin has a density of from 0.94 g/cc to 0.97 g/cc, and a melt index, 12, of from 0.2 g/10 min to 1 g/10 min, and (i) a low density polyethylene (LDPE) wherein the LDPE has a density of from 0.915 g/cc to 0.925 g/cc and a melt index, 12, of from 0.1 g/10 min to 1 g/10 min, or (ii) a linear low density polyethylene (LLDPE) wherein the LLDPE has a density of from 0.915 g/cc to 0.945 g/cc and a melt index, 12, from 0.1 g/10 min to 1 g/10 min, or (iii) a combination of (i) and (ii).

### TECHNICAL FIELD

Embodiments of the present disclosure generally relate to packaging film; and more specifically, to collation shrink film and the preparation of such film.

### BACKGROUND

Using recycled materials is thought to be better for the environment and decreases the waste of natural resources that are used for disposable products. Typically, the largest source for recycled material is the plastics packaging industry (e.g., plastics used in manufacturing containers such as milk jugs, plastic bags and refillable plastic bottles). It would be favorable for the plastics industry to develop methods for recycling plastic material, which would otherwise go to waste by being burned or placed in a landfill. However, the use of recycled materials has drawbacks. It is generally recognized in the art that recycled materials often result in products that have physical properties which are generally less acceptable than products made from virgin materials. As a result, the amount of recycled materials used in products is often limited due to the lost in physical properties of products prepared from recycled materials.

One end-use where there is a growing demand for recycled materials is in collation shrink packaging. The process of shrink packaging generally involves wrapping an article(s) or item(s) in a heat-shrinkable, collation shrink film (CSF) to form a package, and then heat shrinking the film by exposing the film to sufficient heat to cause shrinkage of the film and intimate contact between the film and the article. Collation shrink films (also known as “shrink wrap film”, “heat shrink film” or “shrink film”), among other properties, need to possess (1) good shrinkage with sufficient stiffness allowing the film to be correctly wrapped around the items being packaged, (2) sufficient dimensional shrinkage to ensure a snug fit, and (3) a low enough coefficient of friction (COF). For example, films appropriate for use as collation shrink film must have a high thermal shrink force to ensure a tight fit and high tensile strength to withstand handling and abuse during transportation with excellent optical properties such as low haze and high gloss with good clarity. This is typically achieved using low density polyethylene (LDPE) and/or linear low-density polyethylene (LLDPE) due to the good shrinkage properties of LDPE and LLDPE.

High density polyethylene (HDPE) is a plastic that has a high potential of being used as a PCR because HDPE can be easily recycled; and HDPE is a good resource for PCR since HDPE is one of the most commonly used plastics in manufacturing containers such as milk jugs, plastic bags and refillable plastic bottles. Furthermore, nearly all HDPE containers are made from same-grade resins, a fractional melt index homopolymer; and use of recycled HDPE results in a homogeneous feed stream with consistent material characteristics evident in predictable performance properties and flow (processing) characteristics. Indeed, recycled HDPE has been used as PCR to manufacture plastic wood (lumber), recycled plastic furniture, lawn and garden products, buckets, crates, office products, and automobile parts. However, the use of PCR for manufacturing collation shrink film is limited due to (1) the lack of homogeneity of the PCR resin; (2) the high contamination of the PCR resin, and (3) the defects in films (e.g., undesirable gel formation; reduction in processability; and degradation in the mechanical properties of the film) that the use of PCR creates. Therefore, there is a need to find a solution to the above defect problem in films when using recycled products to produce films or other articles without impacting the quality of the films or other articles.

One reference that discloses the use of HDPE and LDPE includes U.S. Pat. No. 7,422,786, which discloses a 3-layer shrink film having a core layer including combining HDPE with LDPE; and skin layers including metallocene polyethylene (mPE) or LLDPE to provide a film structure with beneficial properties such as good stiffness, high clarity, and/or excellent shrink performance.

Other collation shrink films made from various polymer blends are known in the art and are described, for example, in EP1941998A1; EP2875948A1; WO2012/164308A1; WO2013/081742A1; U.S. Patent Application Publication Nos. 2002/0187360; and 2005/0064161A1; and U.S. Pat. Nos. 6,187,397; 6,340,532; 6,368,545; and 6,824,886.

None of the above prior art references are believed to provide a CSF film product that is made from a clean stream of post-consumer resin (PCR) HDPE with a certain melt index (MI) and density; and that is a fully recyclable monomaterial PE structure. Also, none of the prior art references are believed to disclose a PCR polymer blend composition to make a CSF film product for use in a 3-layer film structure having the above PCR blend in a core layer combined with two skin layers on each side surface of the PCR blend core layer.

### SUMMARY

Disclosed in embodiments herein are shrink films. The shrink films comprise a monolayer or multi-layer film having at least one layer comprising a formulated resin; wherein the formulated resin comprises: a post-consumer recycled resin sourced from recycled high density polyethylene resin; wherein the post-consumer recycled resin has a density of from 0.94 g/cc to 0.97 g/cc, a melt index, 12, of from 0.2 g/10 min to 1 g/10 min, and (i) a low density polyethylene (LDPE) wherein the LDPE has a density of from 0.915 g/cc to 0.925 g/cc and melt index, 12, of from 0.1 g/10 min to 1 g/10 min, or (ii) a linear low density polyethylene (LLDPE) wherein the LLDPE has a density of from 0.915 g/cc to 0.945 g/cc and melt index, 12, from 0.1 g/10 min to 1 g/10 min, or (iii) a combination of (i) and (ii).

Also disclosed herein are methods of manufacturing the shrink films. The methods comprise providing a formulated resin, and forming a monolayer or multilayer film from the formulation resin. The formulated resin comprises: a post-consumer recycled resin sourced from recycled high density polyethylene resin; wherein the post-consumer recycled resin has a density of from 0.94 g/cc to 0.97 g/cc, a melt index, 12, of from 0.2 g/10 min to 1 g/10 min, and (i) a low density polyethylene (LDPE) wherein the LDPE has a density of from 0.915 g/cc to 0.925 g/cc and melt index, 12, of from 0.1 g/10 min to 1 g/10 min, or (ii) a linear low density polyethylene (LLDPE) wherein the LLDPE has a density of from 0.915 g/cc to 0.945 g/cc and melt index, 12, from 0.1 g/10 min to 1 g/10 min, or (iii) a combination of (i) and (ii).

Also disclosed herein are a multilayer shrink films. The multilayer shrink films comprise a core layer and two skin layers, wherein the skin layers include high optics skin layers, and wherein the core layer comprises a formulated resin. The formulated resin comprises: a post-consumer recycled resin sourced from recycled high density polyethylene resin; wherein the post-consumer recycled resin has a density of from 0.94 g/cc to 0.97 g/cc, a melt index, 12, of from 0.2 g/10 min to 1 g/10 min, and (i) a low density polyethylene (LDPE) wherein the LDPE has a density of from 0.915 g/cc to 0.925 g/cc and melt index, 12, of from 0.1 g/10 min to 1 g/10 min, or (ii) a linear low density polyethylene (LLDPE) wherein the LLDPE has a density of from 0.915 g/cc to 0.945 g/cc and melt index, 12, from 0.1 g/10 min to 1 g/10 min, or (iii) a combination of (i) and (ii).

Further disclosed herein are articles packaged using a monolayer or multilayer shrink film as described herein.

### DETAILED DESCRIPTION

Reference will now be made in detail to embodiments of the shrink films containing PCR material. The films may be used in collation shrink applications; however, it is noted that this is merely an exemplary an illustrative implementation of the embodiments disclosed herein. The embodiments are applicable to other technologies that desire incorporation of PCR material; having a low number of defects; exhibiting good mechanical properties; and exhibiting good shrink properties.

As used herein, the term “polyethylene” or “ethylene-based polymer” shall mean polymers comprising greater than 50% by mole of units which have been derived from ethylene monomer. This includes polyethylene homopolymers or copolymers (meaning units derived from two or more comonomers). Common forms of polyethylene known in the art include low density polyethylene (LDPE); linear low density polyethylene (LLDPE); medium density polyethylene (MDPE); and high density polyethylene (HDPE).

The term “LDPE” may also be referred to as “high pressure ethylene polymer” or “highly branched polyethylene” and is defined to mean that the polymer is partly or entirely homopolymerized or copolymerized in autoclave or tubular reactors at pressures above 14,500 psi (100 MPa) with the use of free-radical initiators, such as peroxides (see for example U.S. Pat. No. 4,599,392). LDPE resins typically have a density in the range of 0.915 to 0.935 g/cm.

The term “LLDPE” includes resin made using Ziegler-Natta catalyst systems as well as resin made using single-site catalysts, including, but not limited to, bis-metallocene catalysts (sometimes referred to as “m-LLDPE”) and constrained geometry catalysts, and resin made using post-metallocene, molecular catalysts. LLDPE includes linear, substantially linear or heterogeneous polyethylene copolymers or homopolymers. LLDPEs contain less long chain branching than LDPEs and includes the substantially linear ethylene polymers which are further defined in U.S. Pat. Nos. 5,272,236; 5,278,272; 5,582,923; and 5,733,155; the homogeneously branched linear ethylene polymer compositions such as those in U.S. Pat. No. 3,645,992; the heterogeneously branched ethylene polymers such as those prepared according to the process disclosed in U.S. Pat. No. 4,076,698; and/or blends thereof (such as those disclosed in U.S. Pat. No. 3,914,342 or 5,854,045). The LLDPE resins can be made via gas-phase, solution-phase or slurry polymerization or any combination thereof, using any type of reactor or reactor configuration known in the art.

The term “MDPE” refers to polyethylenes having densities from 0.926 g/cc to 0.945 g/cc. “MDPE” is typically made using chromium or Ziegler-Natta catalysts or using single-site catalysts including, but not limited to, bis-metallocene catalysts and constrained geometry catalysts.

The term “HDPE” refers to polyethylenes having densities greater than 0.945 g/cc, which are generally prepared with Ziegler-Natta catalysts, chrome catalysts or single-site catalysts including, but not limited to, bis-metallocene catalysts and constrained geometry catalysts.

A “post-consumer recycled (PCR) material” is defined by ISO 14021:2016 as a material generated by households or by commercial, industrial and institutional facilities in such facilities' role as end-users of the product which can no longer be used for the product's intended purpose. PCR materials include returns of material from the distribution chain.

As used throughout this specification, the abbreviations given below have the following meanings, unless the context clearly indicates otherwise: “=” means “equal to”; “@” means “at”; “<” means “less than”; “>” means “greater than”; “I₂” means “melt index” measured at 2.16 kg and 190° C.; g=gram(s); mg=milligram(s); pts=parts by weight; kg=kilogram(s); Kg/h=kilograms per hour; g/cc=gram(s) per cubic centimeter; kg/m³=kilogram(s) per cubic meter; g/mol=gram(s) per mole; L=liter(s); mL=milliliter(s); g/L=gram(s) per liter; Mw=weight average molecular weight; Mn=number average molecular weight; Mz=z-average molecular weight; m=meter(s); μm=micron(s): mm=millimeter(s); cm=centimeter(s); min=minute(s); s=second(s); mm/s²=millimeter(s) per second squared; mm/s=millimeter(s) per second; ms=millisecond(s); hr=hour(s); mm/min=millimeter(s) per minute; m/s=meter(s) per second; ° C.=degree(s) Celsius; ° C./min=degree(s) Celsius per minute; mPa·s=millipascals-second(s); MPa=Megapascal(s); kPa=kilopascal(s); Pa·s/m²=pascals-second(s) per meter squared; N=newton(s); cN=centinewton(s); rpm=revolution(s) per minute; mm²=millimeter(s) squared; g/10 min=gram(s) per 10 minutes; J=Joule(s); J/g=Joule(s) per gram; %=percent; eq %=equivalent percent; vol %=volume percent; and wt %=weight percent.

Unless stated otherwise, all percentages, parts, ratios, and like amounts, are defined by weight. For example, all percentages stated herein are weight percentages (wt %), unless otherwise indicated.

Temperatures are in degrees Celsius (° C.), and “ambient temperature” means between 20° C. and 25° C., unless specified otherwise.

In one or more embodiments, the present invention relates to a shrink film having at least one layer comprising a formulated resin. In embodiments herein, the at least one layer may comprise at least 50 wt. %, at least 75 wt. %, at least 80 wt. %, at least 85 wt. %, at least 90 wt. %, at least 95 wt. %, at least 97 wt. %, at least 99 wt. %, or 100 wt. % of the formulated resin. The shrink film may be a fully recyclable mono-material PE structure without any barrier layer(s) added to the film PE product structure.

As previously noted herein, the formulated resin comprises a post-consumer recycled resin sourced from recycled high density polyethylene resin, and (i) a low density polyethylene (LDPE), or (ii) a linear low density polyethylene (LLDPE), or (iii) a combination of (i) and (ii). In one or more embodiments herein, the formulated resin comprises from 20 weight percent to 100 weight percent (alternatively, from a lower limit of 30, 35, 40, 50, or 60 weight percent to an upper limit of 100, 90, 80, or 75 weight percent) of the post-consumer recycled resin. In some embodiments, the formulated resin comprises from 30 weight percent to 100 weight percent, from 35 weight percent to 100 weight percent, from 35 weight percent to 90 weight percent, or from 40 weight percent to 80 weight percent of the post-consumer recycled resin. In addition to the amount of post-consumer recycled resin in the formulated resin, in one or more embodiments herein, the formulated resin concentration of component (i) is from 0 weight percent to 60 weight percent, or alternatively, from 5 weight percent to 60 weight percent, from 5 weight percent to 50 weight percent, from 5 weight percent to 40 weight percent, from 5 weight percent to 30 weight percent, or from 10 weight percent to 30 weight percent. In addition to the amount of post-consumer recycled resin and component (i) in the formulated resin, in one or more embodiments herein, the formulated resin concentration of component (ii) is from 0 weight percent to 60 weight percent, or alternatively, from 10 weight percent to 60 weight percent, from 25 weight percent to 60 weight percent, from 30 weight percent to 60 weight percent, from 30 weight percent to 50 weight percent, or from 35 weight percent to 50 weight percent. In some embodiments, the formulated resin comprises PCR and LDPE in the amounts previously mentioned. In other embodiments, the formulated resin comprises PCR and LLDPE in the amounts previously mentioned. In further embodiments, the formulated resin comprises PCR, LDPE, and LLDPE in the amounts previously mentioned.

The post-consumer recycled resin is sourced from recycled high density polyethylene resin. The post-consumer recycled resin has a density of from 0.94 g/cc to 0.97 g/cc, a melt index, 12, of from 0.2 g/10 min to 1 g/10 min. All individual values and subranges of are included and disclosed herein. For example, in some embodiments, the post-consumer recycled resin has a density of from 0.94 g/cc to 0.97 g/cc (alternatively, 0.940 g/cc to 0.970 g/cc, 0.945 g/cc to 0.970 g/cc, 0.945 g/cc to 0.965 g/cc, or 0.945 g/cc to 0.960 g/cc), and a melt index, 12, of from 0.2 g/10 min to 1 g/10 min (alternatively, from 0.2 g/10 min to 1.0 g/10 min, from 0.2 g/10 min to 0.8 g/10 min, from 0.2 g/10 min to 0.6 g/10 min, from 0.2 g/10 min to 0.5 g/10 min, or from 0.2 g/10 min to 0.4 g/10 min).

In general, the PCR resin may be sourced from packaging waste, such as material generated by households or by commercial, industrial and institutional facilities in their role as end-users of the product. An objective of the present invention to provide a formulated PCR solution for use in shrink films, wherein a clean PCR stream is used in the shrink film. In one or more embodiments, the post-consumer recycled resin is sourced from HDPE plastic containers. In one or more embodiments, the post-consumer recycled resin is sourced from HDPE blow-molded bottles (e.g., milk bottles, sauce bottles, and the like). In one embodiment, the HDPE blow molded bottles have a melt index, 12, of 0.30 g/10 min±0.20 g/10 min and a density 0.95 g/cm³±0.02 g/cm³.

In embodiments herein, the LDPE has a density of from 0.915 g/cc to 0.925 g/cc and a melt index, 12, of from 0.1 g/10 min to 1 g/10 min. All individual values and subranges of are included and disclosed herein. For example, in some embodiments, the LDPE has a density of from 0.915 g/cc to 0.925 g/cc (alternatively, 0.917 g/cc to 0.925 g/cc, 0.919 g/cc to 0.925 g/cc, or 0.919 g/cc to 0.923 g/cc), and a melt index, 12, of from 0.1 g/10 min to 1 g/10 min (alternatively, from 0.1 g/10 min to 1.0 g/10 min, from 0.1 g/10 min to 0.8 g/10 min, from 0.1 g/10 min to 0.6 g/10 min, from 0.1 g/10 min to 0.5 g/10 min, or from 0.1 g/10 min to 0.4 g/10 min).

Examples of suitable LDPEs can include commercially available resins, such as, for example, LDPE 150E available from The Dow Chemical Company or LDPE 310E available from The Dow Chemical Company.

In embodiments herein, the LLDPE has a density of from 0.915 g/cc to 0.945 g/cc and a melt index, 12, from 0.1 g/10 min to 1 g/10 min. All individual values and subranges of are included and disclosed herein. For example, in some embodiments, the LLDPE has a density of from 0.915 g/cc to 0.945 g/cc (alternatively, 0.915 g/cc to 0.940 g/cc, 0.915 g/cc to 0.938 g/cc, or 0.917 g/cc to 0.938 g/cc), and a melt index, 12, of from 0.1 g/10 min to 1 g/10 min (alternatively, from 0.1 g/10 min to 1.0 g/10 min, from 0.1 g/10 min to 0.8 g/10 min, from 0.1 g/10 min to 0.6 g/10 min, from 0.1 g/10 min to 0.5 g/10 min, or from 0.1 g/10 min to 0.4 g/10 min).

Examples of suitable LLDPEs can include commercially available compounds such as TUFLIN™, DOWLEX™, DOWLEX™ NG, and ELITE™ resins (all available from The Dow Chemical Company) and mixtures thereof; ENABLE™ and EXCEED™ resins (both available from ExxonMobil) and mixtures thereof; LUMICENE™ and SUPERTOUGH™ resins (both available from Total) and mixtures thereof; and two or more of the above resins in a blend. Specific examples of suitable LLDPEs may include, for example, DOWLEX™ 2045G resin, DOWLEX™ 2049G resin, DOWLEX™ 2098P resin, DOWLEX™ 2038.68G resin, DOWLEX™ 2645G resin and DOWLEX™ NG 5045P resin (all available from The Dow Chemical Company) and mixtures thereof.

In embodiments described herein, the formulated resin may have a density of 0.925 g/cc to 0.960 g/cc. All individual values and subranges of at least 0.925 g/cc to 0.960 g/cc are included and disclosed herein. For example, in some embodiments, the formulated resin has a density of from 0.925 g/cm³ to 0.955 g/cm³, 0.930 g/cm³ to 0.955 g/cm³, 0.935 g/cm³ to 0.955 g/cm³, or 0.935 g/cm³ to 0.950 g/cm³. Density may be measured in accordance with ASTM D792.

In addition to the density, the formulated resin may have a molecular weight distribution (Mw/Mn) of from 2.0 to 10.0. All individual values and subranges of from 2.0 to 10.0 are included and disclosed herein. For example, in some embodiments, the formulated resin may have an Mw/Mn ratio from a lower limit of 2.5, 3.0, 3.5, 4.0, 4.5, 5.0, 5.5, or 6.0 to an upper limit of 10.0, 9.5, 9.0, 8.5, or 8.0. In other embodiments, the formulated resin may have an Mw/Mn ratio of from 5.0 to 10.0. In further embodiments, the formulated resin may have an Mw/Mn ratio of from 6.0 to 9.0. In further embodiments, the formulated resin may have an Mw/Mn ratio of from 6.0 to 8.5. Molecular weight distribution can be described as the ratio of weight average molecular weight (M_{w}) to number average molecular weight (Mₙ) (i.e., M_{w}/Mₙ), and can be measured by gel permeation chromatography techniques.

In addition to the density and molecular weight distribution, the formulated resin may have a melt index, 12, of 0.1 g/10 min to 1.0 g/10 min. All individual values and subranges of 0.1 g/10 min to 1.0 g/10 min are included and disclosed herein. For example, in some embodiments, the polyethylene composition may have a melt index, 12, of from 0.1 g/10 min to 0.8 g/10 min, from 0.1 g/10 min to 0.6 g/10 min, from 0.1 g/10 min to 0.5 g/10 min, or from 0.1 g/10 min to 0.4 g/10 min. Melt index, 12, may be measured in accordance with ASTM D1238 (190° C. and 2.16 kg).

In addition to the density, molecular weight distribution, and melt index, 12, the formulated resin may have a melt flow ratio, I10/I2, of from 10.0 to 25.0. All individual values and subranges of from 10.0 to 25.0 are included and disclosed herein. For example, in some embodiments, the formulated resin may have a melt flow ratio, I10/I2, ranging from a lower limit of 10.0, 12.0, or 14.0 to an upper limit of 25.0, 23.0, or 22.0. In one or more embodiments, the formulated resin may have a melt flow ratio, I10/I2, of from 12.0 to 25.0, from 14.0 to 23.0, or from 14.0 to 22.0. Melt index, 110, may be measured in accordance with ASTM D1238 (190° C. and 10.0 kg).

In addition to the density, molecular weight distribution, melt index, 12, and melt flow ratio, I10/I2, the formulated resin may have a melt flow ratio, I21/I2, of from 25 to 200. All individual values and subranges of from 25 to 200 are included and disclosed herein. For example, in some embodiments, the formulated resin may have a melt flow ratio, I21/I2, ranging from a lower limit of 25, 30, 40, or 50 to an upper limit of 200, 175, 150, 125, 110, or 90. In one or more embodiments, the formulated resin may have a melt flow ratio, I21/I2, of from 40 to 150, from 40 to 125, or from 50 to 110. Melt index, I21, may be measured in accordance with ASTM D1238 (190° C. and 21.6 kg).

In addition to the density, molecular weight distribution, melt index, 12, melt flow ratio, I10/I2, and I21/I2, the formulated resin may have a number average molecular weight, Mn (g/mol), of from 10,000 to 50,000 g/mol. All individual values and subranges of from 10,000 to 50,000 g/mol are included and disclosed herein. For example, the formulated resin may have a Mn from 12,000 to 50,000 g/mol, 12,000 to 45,000 g/mol, 12,000 to 30,000 g/mol, or 12,000 to 27,000 g/mol.

In addition to the density, molecular weight distribution, melt index, 12, melt flow ratio, I10/I2, I21/I2, and number average molecular weight, the formulated resin may have a weight average molecular weight, Mw (g/mol), of from 80,000 to 200,000 g/mol. All individual values and subranges of from 80,000 to 200,000 g/mol are included and disclosed herein. For example, the formulated resin may have a Mw from 95,000 to 185,000 g/mol, 100,000 to 175,000 g/mol, or 110,000 to 170,000 g/mol.

In addition to the density, molecular weight distribution, melt index, 12, melt flow ratio, I10/I2, I21/I2, number average molecular weight, and weight average molecular weight, the formulated resin may have a z average molecular weight, Mz (g/mol), of from 300,000 to 1,000,000 g/mol. All individual values and subranges of from 300,000 to 1,000,000 g/mol are included and disclosed herein. For example, the formulated resin may have an Mz from 350,000 to 950,000, 400,000 to 900,000 g/mol, or 500,000 to 900,000 g/mol.

In addition to the density, molecular weight distribution, melt index, 12, melt flow ratio, I10/I2, I21/I2, number average molecular weight, weight average molecular weight, and z average molecular weight, the formulated resin may have an Mz/Mw of from 3 to 10. All individual values and subranges of from 3 to 10 are included and disclosed herein. For example, in some embodiments, the formulated resin may have an Mz/Mw of from a lower limit of 3, 3.0, 3.5, or 4.0 to an upper limit of 10, 10.0, 9.0, 8.5, 8.0, 7.5, 7.0, or 6.5. In other embodiments, the formulated resin may have an Mz/Mw ratio of from 3.0 to 9.0, from 3.0 to 8.0, from 3.0 to 7.5, or from 3.5 to 6.5. Mz can be measured by gel permeation chromatography techniques.

In addition to the density, molecular weight distribution, melt index, 12, melt flow ratio, I10/I2, I21/I2, number average molecular weight, weight average molecular weight, z average molecular weight, and Mz/Mw, the formulated resin may have a melt strength of from 0.03 to 0.25 N. All individual values and subranges of from 0.03 to 0.25 N are included and disclosed herein. For example, in some embodiments, the formulated resin may have a melt strength of from 0.05 to 0.20 N or from 0.06 to 0.17 N.

In embodiments herein, the formulation resin may include one or more additives. The additives in combination with the composition of the present invention may be formulated to enable performance of specific functions while maintaining the excellent benefits/properties of the formulation resin. For example, the following additives may be blended with the formulation resin include: antioxidants, pigments, colorants, UV stabilizers, UV absorbers, processing aids, fillers, slip agents, anti-blocking agents, and the like; and mixtures thereof.

The optional additive, when used in the formulated resin, can be present in an amount generally in the range of from 0 wt % to 10 wt % in one embodiment; from about 0.001 wt % to 5 wt % in another embodiment; and from 0.001 wt % to 3 wt % in still another embodiment. In other embodiments the optional additive may be added to the formulated resin in an amount of less than 5 wt % in one general embodiment, less than 3 wt % in another embodiment, and less than 1 wt % in still another embodiment.

The shrink film may be a monolayer film or a multilayer film. In one or more embodiments herein, the multilayer film has at least one layer comprising the formulated resin. In other embodiments, the multilayer film has at least three layers, with at least one layer comprising the formulated resin. In further embodiments, the multilayer film comprises a core layer and two skin layers, wherein one skin layer (of the two skin layers) is on each side of the core layer, and the core layer comprises the formulated resin. The core layer may comprise at least 50 wt. %, at least 75 wt. %, at least 80 wt. %, at least 85 wt. %, at least 90 wt. %, at least 95 wt. %, at least 97 wt. %, at least 99 wt. %, or 100 wt. % of the formulated resin.

A process for making the formulated resin includes, for example, mixing together components (a), (b) and (c) described above; and any desired optional additive. Mixing may be achieved using a dry blend process or a melt blend process, both of which are well-known processes to those skilled in the art of mixing. In some embodiments, the formulated resin is a melt blend formulated resin.

Some of the advantageous/beneficial properties exhibited by a melt blend formulated resin, can include, for example: a formulated resin with less gel formation; and a more homogeneous formulated resin. Without being bound by theory, it is believed that the melt blend process can break the gel and decrease the gel size. It is also believed, that the melt filtration system used in melt blending may also help for the gel reduction. Melt blending has an additional mixing step which enables better mixing compared to a dry blend process.

In one or more embodiments, the shrink monolayer or multilayer film may have any desired length and width; and has a thickness of, for example, from 30 microns to 120 microns. All individual values and subranges of from 30 microns to 120 microns are included and disclosed herein. For example, in some embodiments, the shrink monolayer or multilayer film may have a thickness of 30 microns to 100 microns, from 30 microns to 90 microns, or from 30 microns to 80 microns.

Also disclosed herein are methods of manufacturing the shrink films. The methods comprise providing a formulated resin as described in one or more embodiments herein, and forming a monolayer or multilayer film from the formulation resin. Any conventional film forming process may be used to form the monolayer or multilayer film. An example includes a blown film line (for example, a blow line manufactured by Battenfeld Gloucester) using typical fabrication parameters easily determined by those skilled in the art of producing blown films.

In some embodiments, the shrink film may be a multilayer shrink film having an A/B/A film structure can be prepared, wherein each A is a skin layer of the same material; and B is the core layer disposed in between the skin layers A, or an A/B/C film structure wherein A and C are skin layers having a different material composition, and B is the core layer disposed between the skin layers A and C. In both embodiments, the B core layer comprises the formulated resin as described herein. The shrink film can have a 1:2:1 ratio of the skin layers and the core layer, respectively. Each skin layer used in the present invention film may independently have a thickness of from 8 μm to 30 μm in one embodiment, from 10 μm to 25 μm in another embodiment, or from 12 μm to 20 μm in still another embodiment. The core layer used in the present invention film may have a thickness of, for example, from 20 μm to 60 μm in one embodiment, from 25 μm to 55 μm in another embodiment, or from 30 μm to 50 μm in still another embodiment. The present invention is not limited to 3 layers, and can include more than 3 layers, provided that at least one core or inner layer of the multilayer shrink film comprises the formulated resin and still allows for the proper balance of properties, such as, stiffness, toughness, and shrinkage.

Each of the skin layers of a multilayer shrink film comprise one or more ethylene-based polymeric materials, including, for example, HDPE, LDPE, MDPE, LLDPE and mixtures thereof. In one or more embodiments, the skin layers useful in the present invention may independently comprise HDPE, LDPE, LLDPE, and mixtures thereof. In some embodiments, each skin layer independently comprises LDPE, LLDPE and HDPE, wherein the LDPE has a density of from 0.915 g/cc to 0.925 g/cc and a melt index, 12, of from 0.2 g/10 min to 2.0 g/10 min, the LLDPE has a density of from 0.915 g/cc to 0.940 g/cc and a melt index, 12, of from 0.2 g/10 min to 2.0 g/10 min, and the HDPE has a density of from 0.945 g/cc to 0.965 g/cc and a melt index, 12, of from 0.04 g/10 min to 1.0 g/10 min. In other embodiments, each skin layer independently comprises LDPE and LLDPE, wherein the LDPE has a density of from 0.915 g/cc to 0.925 g/cc and a melt index, 12, of from 0.1 g/10 min to 2.0 g/10 min, and the LLDPE has a density of from 0.915 g/cc to 0.940 g/cc and a melt index, 12, of from 0.2 g/10 min to 2.0 g/10 min.

In one or more embodiments herein, the shrink film may exhibit one or more of the following properties: an tensile strength of from 20 MPa to 40 MPa, as measured by ASTM D882; an MD shrinkage of from 40 percent to 70 percent (alternatively, from 45 percent to 70 percent or from 50 percent to 70 percent) and an TD shrinkage from 10 percent to 50 percent (alternatively, from 12 percent to 50 percent or from 15 percent to 50 percent), as measured by ASTM D2732-03 at 130° C. and 20 seconds; a haze of from 5 percent to 50 percent (alternatively, 5 percent to 30 percent or 5 percent to 20 percent), as measured by ASTM D1003. In addition to the tensile strength, shrinkage, and haze properties, the shrink films described herein may also exhibit an improvement in toughness, which is quantified in the range of higher than 70 g on dart impact (A) (60 micron film) in one embodiment; higher than 75 g on dart impact (A) (60 micron film) in another embodiment; and higher than 80 g on dart impact (A) (60 micron film) in still another embodiment.

The monolayer or multilayer shrink film as described herein can be used, for example, in packaging applications. In one or more embodiments, articles are packaged using the monolayer or multilayer shrink films described herein.

TEST METHODS

### Density

Density is measured according to ASTM D792, Method B in reported in grams/cubic centimeter (g/cc or g/cm3).

### Melt Index

Melt index (MI), or 12, is measured in accordance with ASTM D 1238, Condition 190° C./2.16 kg, Procedure B, and reported in grams eluted per 10 minutes (g/10 min). 110, is measured in accordance with ASTM D 1238, Condition 190° C./10 kg, Procedure B, and reported in grams eluted per 10 minutes (g/10 min).

### Melt Strength

Melt strength is measured at 200° C. using a Goettfert Rheotens 71.97 (Goettfert Inc.; Rock Hill, S.C.), melt fed with a Goettfert Rheotester 2000 capillary rheometer equipped with a flat entrance angle (180 degrees) of length of 30 mm and diameter of 2 mm. The pellets are fed into the barrel (L=300 mm, Diameter-12 mm), compressed and allowed to melt for 10 minutes before being extruded at a constant piston speed of 0.2 mm/s, which corresponds to a wall shear rate of 28.8 s⁻¹ at the given die diameter. The extrudate passes through the wheels of the Rheotens located at 100 mm below the die exit and is pulled by the wheels downward at an acceleration rate of 6 mm/s². The force (in N) exerted on the wheels is recorded as a function of the velocity of the wheels (mm/s). Melt strength is reported as the plateau force (N) before the strand breaks.

### Gel Permeation Chromatography (GPC)

The chromatographic system consisted of a PolymerChar GPC-IR (Valencia, Spain) high temperature GPC chromatograph equipped with an internal IR5 infra-red detector (IR5). The autosampler oven compartment was set at 1600 Celsius and the column compartment was set at 150° Celsius. The columns used were 4 Agilent “Mixed A” 30 cm 20-micron linear mixed-bed columns and a 20-um pre-column. The chromatographic solvent used was 1,2,4 trichlorobenzene and contained 200 ppm of butylated hydroxytoluene (BHT). The solvent source was nitrogen sparged. The injection volume used was 200 microliters and the flow rate was 1.0 milliliters/minute.

Calibration of the GPC column set was performed with 21 narrow molecular weight distribution polystyrene standards with molecular weights ranging from 580 to 8,400,000 and were arranged in 6 “cocktail” mixtures with at least a decade of separation between individual molecular weights. The standards were purchased from Agilent Technologies. The polystyrene standards were prepared at 0.025 grams in 50 milliliters of solvent for molecular weights equal to or greater than 1,000,000, and 0.05 grams in 50 milliliters of solvent for molecular weights less than 1,000,000. The polystyrene standards were dissolved at 80 degrees Celsius with gentle agitation for 30 minutes. The polystyrene standard peak molecular weights were converted to polyethylene molecular weights using Equation 1 (as described in Williams and Ward, J. Polym. Sci., Polym. Let., 6, 621 (1968)).:

M_{polyethylene}=A×(M_{polystyrene})^{B} (EQ1)

where M is the molecular weight, A has a value of 0.4315 and B is equal to 1.0.

A fifth order polynomial was used to fit the respective polyethylene-equivalent calibration points. A small adjustment to A (from approximately 0.375 to 0.445) was made to correct for column resolution and band-broadening effects such that linear homopolymer polyethylene standard is obtained at 120,000 Mw.

The total plate count of the GPC column set was performed with decane (prepared at 0.04 g in 50 milliliters of TCB and dissolved for 20 minutes with gentle agitation.) The plate count (Equation 2) and symmetry (Equation 3) were measured on a 200 microliter injection according to the following equations:

$$Plate Count = 5.54 * {( \frac{( {RV}_{Peak Max}}{Peak Width at \frac{1}{2} height} )}^{2} \qquad ( EQ2 )$$

where RV is the retention volume in milliliters, the peak width is in milliliters, the peak max is the maximum height of the peak, and ½ height is ½ height of the peak maximum.

$$Symmetry = \frac{( Rear Peak {RV}_{one tenth height} - {RV}_{Peak max} )}{( {RV}_{Peak max} - Front Peak {RV}_{one tenth height} )} \qquad ( EQ3 )$$

where RV is the retention volume in milliliters and the peak width is in milliliters, Peak max is the maximum position of the peak, one tenth height is 1/10 height of the peak maximum, and where rear peak refers to the peak tail at later retention volumes than the peak max and where front peak refers to the peak front at earlier retention volumes than the peak max. The plate count for the chromatographic system should be greater than 18,000 and symmetry should be between 0.98 and 1.22.

Samples were prepared in a semi-automatic manner with the PolymerChar “Instrument Control” Software, wherein the samples were weight-targeted at 2 mg/ml, and the solvent (contained 200 ppm BHT) was added to a pre nitrogen-sparged septa-capped vial, via the PolymerChar high temperature autosampler. The samples were dissolved for 2 hours at 1600 Celsius under “low speed” shaking.

The calculations of Mn_{(GPC)}, Mw_{(GPC)}, and MZ_{(GPC)} were based on GPC results using the internal IR5 detector (measurement channel) of the PolymerChar GPC-IR chromatograph according to Equations 4-6, using PolymerChar GPCOne™ software, the baseline-subtracted IR chromatogram at each equally-spaced data collection point (i), and the polyethylene equivalent molecular weight obtained from the narrow standard calibration curve for the point (i) from Equation 1.

$${Mn}_{( GPC )} = \frac{{\sum }^{i} {IR}_{i}}{{\sum }^{i} ( {IR}_{i} / {M}_{{polyethylene}_{i}} )} \qquad ( EQ 4 )$$

$${Mw}_{( GPC )} = \frac{{\sum }^{i} ( {IR}_{i} * {M}_{{polyethylene}_{i}} )}{{\sum }^{i} {IR}_{i}} \qquad ( EQ 5 )$$

$${Mz}_{( GPC )} = \frac{{\sum }^{i} ( {IR}_{i} * {M}_{{polyethylene}_{i}}^{2} )}{{\sum }^{i} ( {IR}_{i} * {M}_{{polyethylene}_{i}} )} \qquad ( EQ 6 )$$

In order to monitor the deviations over time, a flowrate marker (decane) was introduced into each sample via a micropump controlled with the PolymerChar GPC-IR system. This flowrate marker (FM) was used to linearly correct the pump flowrate (Flowrate(nominal)) for each sample by RV alignment of the respective decane peak within the sample (RV(FM Sample)) to that of the decane peak within the narrow standards calibration (RV(FM Calibrated)). Any changes in the time of the decane marker peak are then assumed to be related to a linear-shift in flowrate (Flowrate(effective)) for the entire run. To facilitate the highest accuracy of a RV measurement of the flow marker peak, a least-squares fitting routine is used to fit the peak of the flow marker concentration chromatogram to a quadratic equation. The first derivative of the quadratic equation is then used to solve for the true peak position. After calibrating the system based on a flow marker peak, the effective flowrate (with respect to the narrow standards calibration) is calculated as Equation 7. Processing of the flow marker peak was done via the PolymerChar GPCOne™ Software. Acceptable flowrate correction is such that the effective flowrate should be within +/−1% of the nominal flowrate.

Flowrate(effective)=Flowrate(nominal)*(RV(FM Calibrated)/RV(FM Sample)) (EQ7)

### Melting & Crystallization Temperatures, and Enthalpies

ASTM D3418-Standard Test Method for Transition Temperatures and Enthalpies of Fusion and Crystallization of Polymers by Differential Scanning Calorimetry is used to measure the melting peak temperature (Tm), crystallization temperature (Tc), and the heat of fusion, and delta H crystallization. A DSC-Q2000 instrument is used and is equilibrated at 0.00° C.; and the data storage is placed in the “on” position. A temperature ramp of 10.00° C./min to 200.00° C. is first used and the isothermal is for 5.00 min. After 5 min, the end of cycle 1 is marked. Then, a temperature ramp of 10.00° C./min to 0.00° C. is used and the isothermal is for another 5.00 min. After 5 min, the end of cycle 2 is marked. Another temperature ramp of 10.00° C./min to 200.00° C. is used and the end of cycle 3 is marked ending the procedure.

### Tensile Properties

ASTM D882 is used to measure the tensile strength, tensile elongation and secant modulus of the film.

### Tear

ASTM D1922 is used to measure the tear properties of the film in the machine direction (MD) and the transverse direction (TD).

### Dart

ASTM D1709, Procedure A is used to measure the dart properties of the film.

### Gloss 45°

ASTM D2457 is used to measure the gloss 450 properties of the film.

### Haze

ASTM D1003 is used to measure the haze properties of the film.

### Puncture

Puncture of the film is measured using ASTM D5748 by substituting the use of a 0.5 inch diameter stainless steel probe.

### Shrinkage

ASTM D2732-03 is used to measure the shrinkage properties of the film.

### Clarity

ASTM D1746 may be used to measure the clarity properties of the film.
MD/CD Shrink Force Shrink force is measured in the machine and transverse directions using a ARES-G2 (TA Instruments). The film is mounted in the torsion fixture and the length is measured at the start temperature of 40° C. by the Rheometer measure mode. The shrinkage of the film is monitored under a constant static strain of 0% with a temperature ramp of 20° C./min from 25 C up to 80° C., then 5° C./min from 80 C up to 160° C. The shrinkage behavior including shrink force and shrink temperature of the film could be monitored.

### Examples

The following examples are presented to further illustrate the present invention in detail but are not to be construed as limiting the scope of the claims. Unless otherwise indicated, all parts and percentages are by weight.

Various terms, designations, and raw materials used in the Inventive Examples (Inv. Ex.) and the Comparative Examples (Comp. Ex.) are explained as follows: Table I describes the raw materials used in the Examples.

TABLE I
Raw Materials

| | Melt Index | Density |
|---|---|---|
| Raw Material | (I₂, g/10 min) | (g/cc) |
| HDPE BE0400 | 0.25 | 0.958 |
| LDPE 150E | 0.25 | 0.921 |
| DOWLEX ™ 2038.68G | 1 | 0.935 |
| DOWLEX ™ 2045G | 1 | 0.92 |
| AG-PCR* | 0.46 | 0.924 |
| HD-PCR** | 0.228 | 0.948 |

Notes for Table I:
*AG-PCR is an LLDPE-based PCR obtained from agriculture film.
**“HD-PCR” stands for ‘high density polyethylene PCR.

### Film Formulations

The formulations described in Table II were used to fabricate the various collation shrink film samples.

TABLE II
Formulations for Collation Shrink Film

| | Brief | | Core |
|---|---|---|---|
| | Description | Skin Layers | (Formulated Resin Composition) |
| Comp. Ex. A | No PCR | 40% DOWLEX ™ 2045G + 40% | 40% DOWLEX ™2038.68G + 20% |
| | | LDPE 150E + 20% HDPE BE0400 | LDPE 150E + 40% HDPE BE0400 |
| Comp. Ex. B | 20% AG- | 40% DOWLEX ™2045G + 40% | 40% DOWLEX ™2038.68G + 20% |
| | PCR | LDPE 150E + 20% HDPE BE0400 | LDPE 150E + 40% AG-PCR |
| Inv. Ex. 1 | 20% HD- | 40% DOWLEX ™2045G + 40% | 40% DOWLEX ™2038.68G + 20% |
| | PCR | LDPE 150E + 20% HDPE BE0400 | LDPE 150E + 40% HD-PCR |
| Inv. Ex. 2 | 30% HD- | 40% DOWLEX ™2045G + 40% | 20% DOWLEX ™2045G + 20% |
| | PCR | LDPE 150E + 20% HDPE BE0400 | LDPE 150E + 60% HD-PCR |
| Inv. Ex. 3 | 40% HD- | 40% DOWLEX ™2045G + 60% | 20% DOWLEX ™2045G + 80% |
| | PCR | LDPE 150E | HD-PCR |

Examples 1-3 and Comparative Examples A and B were fabricated using the resin formulations for the layers of the collation shrink films described in Table II and using the following general blown film procedure:

The blown film used in the Examples is a 60 m, three-layer film structure of A/B/C with a layer ratio of 1/2/1, respectively, with layers A and C being the skin layers and have the same composition as outlined in Table II. The films are blown using a blown film line manufactured by Battenfeld Gloucester. The blown film line included the following fabrication parameters: (1) a three-layer (A/B/C) pancake die diameter of 76 mm, a die gap of 2 mm, and an output of ˜15 Kg/h; (2) a die temperature profile of: A=230° C., B=230° C., and C=230° C.; (3) a blow up ratio (BUR) of 3.2, a layflat of 38 cm, and a 1^{st} haul off speed of 6 m/min; (4) an extruder diameter of 32 mm and a L/D ratio of 28; (5) an extruder temperature profile of A=200° C./220° C./230° C./230° C./230° C.; B=200° C./220° C./230° C./230° C./230° C.; and C=200° C./220° C./230° C./230° C./230° C.; and (6) an on-line split winding.

The formulated resin used to form the core layer was further analyzed in Tables III-VI.

TABLE III
Density and Melt Index of Formulated Resins Used in Core Layer

| | | I₂ | I₁₀ | I₂₁ |
|---|---|---|---|---|
| | Density | Melt Index | Melt Index | Melt Index |
| Example No. | (g/cc) | (g/10 min) | (g/10 min) | (g/10 min) |
| Comp. Ex. A | 0.9414 | 0.550 | / | / |
| Comp. Ex. B | 0.9278 | 0.634 | / | / |
| Inv. Ex. 1 | 0.9410 | 0.253 | 4.055 | 16.102 |
| Inv. Ex. 2 | 0.9440 | 0.197 | 4.018 | 17.311 |
| Inv. Ex. 3 | 0.9470 | 0.316 | 6.028 | 30.555 |

TABLE IV
Thermal Characterization of Formulated Resins in Core Layer

| | | | | Delta H |
|---|---|---|---|---|
| | Tm | Heat of Fusion | Tc | crystallization |
| Example No. | (° C.) | (J/g) | (° C.) | (J/g) |
| Comp. Ex. A | / | / | / | / |
| Comp. Ex. B | / | / | / | / |
| Inv. Ex. 1 | 127.51 | 126.6 | 115.93 | 128.2 |
| Inv. Ex. 2 | 128.70 | 125.2 | 117.17 | 128.6 |
| Inv. Ex. 3 | 129.85 | 137.2 | 117.69 | 139.2 |

TABLE V
Conventional GPC Results of Formulated Resin in Core Layer

| | Mn | Mw | Mz | | |
|---|---|---|---|---|---|
| Example No. | (g/mol) | (g/mol) | (g/mol) | Mw/Mn | Mz/Mw |
| Comp. Ex. A | / | / | / | / | / |
| Comp. Ex. B | / | / | / | / | / |
| Inv. Ex. 1 | 20,950 | 133,380 | 583,510 | 6.37 | 4.37 |
| Inv. Ex. 2 | 19,280 | 140,860 | 681,230 | 7.31 | 4.84 |
| Inv. Ex. 3 | 18,600 | 147,480 | 845,960 | 7.93 | 5.74 |

TABLE VI
Melt Strength of Formulated Resin in Core Layer

| Example No. | Melt Strength (N) |
|---|---|
| Comp. Ex. A | / |
| Comp. Ex. B | / |
| Inv. Ex. 1 | 0.150 |
| Inv. Ex. 2 | 0.149 |
| Inv. Ex. 3 | 0.089 |

### Film Properties

Table VII & VIII describes the mechanical properties of the resultant collation shrink film structures obtained from the Examples. As shown in Table VII and VIII, Inv. Ex. 1-3 have quite good mechanical properties, which are very important for collation shrink film applications.

TABLE VII
Mechanical Properties

| | | | 2% | | | 2% |
|---|---|---|---|---|---|---|
| | Tensile | Tensile | Secant | Tensile | Tensile | Secant |
| | Strength | Elongation | Modulus | Strength | Elongation | Modulus |
| | (MD), | (MD) | (MD) | (TD), | (TD) | (TD), |
| Example No. | (MPa) | (%) | (MPa) | (MPa) | (%) | (MPa) |
| Comp. Ex. A | 35.82 | 1018.4 | 496.39 | 34.54 | 1127.55 | 524.34 |
| Comp. Ex. B | 26.79 | 810.97 | 383.43 | 25.64 | 949.37 | 413.46 |
| Inv. Ex. 1 | 29.08 | 863.72 | 445.39 | 28.34 | 1028.88 | 485.68 |
| Inv. Ex. 2 | 28.4 | 796.18 | 449.91 | 28.3 | 984.76 | 500.45 |
| Inv. Ex. 3 | 26.81 | 744.07 | 477.08 | 28.17 | 965.45 | 519.46 |

TABLE VIII
Mechanical Properties

| | Tear | Tear | | |
|---|---|---|---|---|
| | MD | TD | Puncture | Dart A |
| Example No. | (g) | (g) | (J) | (g) |
| Comp. Ex. A | 167.33 | 777.12 | 1.09 | 80 |
| Comp. Ex. B | 211.8 | 1151.4 | 1.26 | 120.7 |
| Inv. Ex. 1 | 120.9 | 974.5 | 1.28 | 110.2 |
| Inv. Ex. 2 | 96.7 | 950.5 | 1.13 | 99.7 |
| Inv. Ex. 3 | 101.5 | 944 | 1.26 | 96.7 |

Table IX describes the optical properties of the collation shrink film structures. When the shrink films of Inv. Ex. 1-3 are compared to the shrink films of Comp. Ex. A (no PCR), the optical performances of the shrink films of Inv. Ex. 1-3 with PCR are almost at the same level as Comp. Ex. A.

TABLE IX
Optical Properties

| | Gloss 45° | Haze | Clarity |
|---|---|---|---|
| Example No. | (%) | (%) | (%) |
| Comp. Ex. A | 45.90 | 15.20 | 86.6 |
| Comp. Ex. B | 39.18 | 17.20 | 82.2 |
| Inv. Ex. 1 | 42.1 | 16.7 | 81.6 |
| Inv. Ex. 2 | 42.2 | 16.4 | 80.3 |
| Inv. Ex. 3 | 50.0 | 14.1 | 84.2 |

Table X describes the shrink performance of the resultant shrink film structures obtained from the Examples. The Inv. Ex. 1-3 show a very good shrink performance, even better than the Comp. Ex. A and B. Good shrink performance is a very important property for collation shrink film applications.

TABLE X
Shrink Performance

| | Shrink | Shrink | Shrinkage MD | Shrinkage TD |
|---|---|---|---|---|
| | Force MD | Force TD | (130° C., 20 s) | (130° C., 20 s) |
| Example No. | (N) | (N) | (%) | (%) |
| Comp. Ex. A | 0.022 | 0.0013 | 54 | 17 |
| Comp. Ex. B | 0.028 | 0.0018 | 61 | 19 |
| Inv. Ex. 1 | 0.041 | 0.0021 | 64 | 18 |
| Inv. Ex. 2 | 0.043 | 0.0028 | 67 | 19 |
| Inv. Ex. 3 | 0.027 | 0.0019 | 63 | 16 |

As shown in the Tables above, the shrink films of the present invention that incorporates HDPE Post Consumer Recycle (PCR) resin exhibit quite good shrink performance and, at the same time, the mechanical properties and optical properties of the shrink films are not compromised. Thus, the HDPE PCR is suitable for shrink film applications.

What is claimed is:

1. A shrink film comprising:
a monolayer or multi-layer film having at least one layer comprising a formulated resin;
wherein the formulated resin comprises:
a post-consumer recycled resin sourced from recycled high density polyethylene resin; wherein the post-consumer recycled resin has a density of from 0.94 g/cc to 0.97 g/cc, and a melt index, I₂, of from 0.2 g/10 min to 1 g/10 min, and
(i) a low density polyethylene (LDPE) wherein the LDPE has a density of from 0.915 g/cc to 0.925 g/cc and a melt index, I₂, of from 0.1 g/10 min to 1 g/10 min, or
(ii) a linear low density polyethylene (LLDPE) wherein the LLDPE has a density of from 0.915 g/cc to 0.945 g/cc and a melt index, I₂, from 0.1 g/10 min to 1 g/10 min, or
(iii) a combination of (i) and (ii).

2. The film of claim 1, wherein the formulated resin comprises from 20 weight percent to 100 weight percent of the post-consumer recycled resin; from 0 weight percent to 60 weight percent of component (i); and from 0 weight percent to 60 weight percent of component (ii).

3. The film of claim 1, wherein the thickness of the film is from 30 microns to 120 microns.

4. The film of claim 1, wherein the film has an tensile strength of from 20 MPa to 40 MPa, as measured by ASTM D882.

5. The film of claim 1, wherein the film has a MD shrinkage of from 40 percent to 70 percent and a TD shrinkage from 10 percent to 50 percent, as measured by ASTM D2732-03 at 130° C. and 20 seconds.

6. The film of claim 1, wherein the film has a haze of from 5 percent to 50 percent, as measured by ASTM D1003.

7. The film of claim 1, wherein the formulated resin is a melt-blended formulated resin.

8. The film of claim 1, wherein the post-consumer recycled resin is sourced from blow-molded plastic bottles.

9. The film of claim 1, wherein the film is a multilayer collation shrink film having a core layer comprising the formulated resin.

10. An article packaged using a film comprising the film of claim 1.
